(19) United States
(12) Patent Application Publication
(10) Pub. No.: US 2009/0111939 A1
(43) Pub. Date: Apr. 30, 2009

(54) Method for Purifying a Contaminated Solvent and Concurrently Producing a Semi-Finished Product for Use in the Production of Panels

(76) Inventor: Roberta Bas, Fiume Veneto (Pordenone) (IT)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 12/225,153

(22) PCT Filed: Mar. 21, 2006
(86) PCT No.: PCT/IT2006/000176

§ 371 Date: Sep. 16, 2008

(51) Int. Cl. C08L 101/00; C08J 5/04

(52) U.S. Cl. 525/54.2; 264/331.11

(57) ABSTRACT

The invention relates to a method for purifying a contaminated solvent and concurrently producing a semi-finished product for use in the production of panels. The inventive method is characterized in that it comprises following steps: a) providing a first mass of fibrous material; b) softening at least part of a second mass of plastic material by impregnating it with a contaminated solvent adapted to at least partially dissolve said plastic material; c) mixing said fibrous material with the mass of softened plastic material to produce a compound; d) pressing said compound at a temperature that is at least equal to the melting temperature of said plastic material to obtain a semi-finished panel and a fraction of evaporated solvent.

The present invention refers to a method for purifying a contaminated solvent and concurrently production a semi-finished product for use in the production of panels.

Nowadays, many production processes, such as in particular those processes involving surface coating, painting and similar operations accompanied by maintenance and cleaning of the related tools and equipment, normally require the use of considerable amounts of solvents. These are substances that, owing to them being highly polluting, must be properly collected and sent to disposal and/or recovery in accordance to the applicable law regulations. In particular, upon having been so used in the above-cited processes, these solvents generally contain quite considerable an amount of residues in a suspended state, such as for instance resins and/or glues that still maintain a fairly good binding power. These materials must be separated from the solvents and properly treated using specially designed processes, so as to prevent them from producing detrimental effects on the environment when disposed of. It can be readily appreciated that purifying the solvents on the one side, and the resins and glues on the other side, involves the use of rather complex equipment and installations, along with a really considerable investment of economic resources.

The problem connected with the disposal of the solvents and the residues contained therein is particularly felt in the woodworking industry, where solvents are largely used to carry out operations such as impregnating, painting, lacquering the vegetal material, as well as to dilute the glues used in the fabrication of the panels used as substitutes for solid wood, such as chipboard panels, plywood, and low-density, high-density and medium-density fibreboard panels, which are commonly known in the art also under the acronyms thereof, i.e. LFD, HDF and MDF.

According to the production methods used up to these days, the panels of the last-mentioned kind are produced starting from wood fragments, generally known as chips in the art, which are first of all caused to undergo grinding processes and then added with sawdust, glue and additives such as urea resins. After drying, the material is placed into proper moulds so as to obtain a kind of mattress that is then pressed, squared, cut into plates and submitted to smoothing.

Only approximately 20% of the wood chips used for the production of MDF panels originate from recycled woodworking scraps and waste. This is due not only to the existing abilities in making use of recovered wood scraps, as well as the actually available amounts of such material, but also to the need for finished panels to be generally obtained with excellent mechanical characteristics through the use of wood fibres that have already been used to other purposes and, as such, heavily and generally denatured.

A need that is markedly and concretely felt within the woodworking industry in general is therefore the ability of developing production processes that do not only allow alternative materials to be produced for use instead of wood-based raw materials of known kind, but also enable processing solvents to be recovered along with the residues contained therein, as well as waste and scraps of fibres that have already gone through various production processes. In particular, the need is felt for the binding power, which—as noted hereinbefore—is still to be found in the residues of resins and glues suspended in the solvents to be purified, to be recovered in order to advantageously make use of this resource in the production of a semi-finished product for use in manufacturing panels that normally involve or require the use of such substances. These alternative materials to wood-based raw materials must of course have mechanical properties similar, if not even superior to the ones typically ensured by currently used wood-based raw materials of known kind.

It is therefore an object of the present invention to provide a method for purifying a contaminated solvent and concurrently producing a semi-finished product for use in the production of panels, which is effective in contributing to the solution of the problem connected with the disposal of chemical processing waste, while improving processes for producing alternative materials to traditional wooden or wood-based materials.

Within this general object, it is a purpose of the present invention to provide a method for purifying a contaminated solvent and concurrently producing a semi-finished product for use in the production of panels, which is capable of being used to purify a wide variety of solvents, the same method being further capable of adapting to varying amounts of the contaminated solvent to be purified.

It is a further purpose of the present invention to provide a method for purifying a contaminated solvent and concurrently producing a semi-finished product for use in the production of panels, in which said may be fully comprised of recycled fibrous material and enables panels to be produced, which have improved processability or workability properties as compared to panels of fibrous materials of known type.

Yet another purpose of the present invention is to provide a method for purifying a contaminated solvent and concurrently producing a semi-finished product for use in the production of panels, which allows for used and potentially polluting materials to be effectively and safely recycled, thereby considerably reducing energy usage and requirements as compared to traditional prior-art processes.

According to the present invention, these aims and objects are reached in a method for purifying a contaminated solvent and concurrently producing a semi-finished product for use in the production of panels, which incorporates the features and characteristics as recited in claim 1 appended hereto.

Further features and advantages of the present invention will be readily understood from the description that is given below by way of non-limiting example.

The inventive method for purifying a contaminated solvent and concurrently producing a semi-finished product for use in the production of panels calls for a first mass of fibrous material to be used. This material may be comprised of a single type of fibres, such as for instance lignocellulose fibres, or a mix of fibres of different nature. For instance, a fibre mix suitable for use in the inventive method is comprised of various synthetic textile and vegetable fibres. In a preferred manner, the fibrous material includes fibres derived from processing waste and scraps, recovered materials or residues from production processes, such as for instance paper-mill sludge, in which fibres are generally too short to be suitable for re-use in the production of paper. The mass of fibrous material may furthermore be provided in the form of layers of agglomerated fibres.

In the case that the fibrous materials has a high water content, such as in the case of paper-mill sludge, appropriate drying operations, in which said sludge is for instance pressed and dehydrated, may be duly provided. Pressing enables the aqueous component in the sludge to be reduced down to anywhere between 30 and 40 wt %, while the subsequent dehydration operation enables said aqueous content to be further brought down to approx. 5 wt %. At such water content, sludge and slurries are generally defined as “dry”.

Upon having been so dried, the resulting dry sludge is in the form of small cylindrical blocks that, at the moment of their use, must be first ground, or fiberized, using corresponding machines provided with adjacent rotating disks, the relative position of which can be properly adjusted to modify both the length and the diameter of the fibres accordingly.

A second mass of plastic material, comprising one or several types or grades of thermoplastic polymers, such as for instance ABS (Acrylonitrile-Butadiene-Styrene), polystyrene, and the like, is impregnated with a contaminated solvent that is due to be purified. In this mass of plastic material there may be of course included also thermosetting polymers, such as phenol-formaldehyde resins, epoxy resins and polyurethanes. The contaminated solvent is recovered as a by-product or waste from such processes as the ones used to clean painting installations, tools and equipment. Owing to its being derived from waste recovery operations, the contaminated solvent may therefore be comprised of a mixture of chemical substances of a different nature, such as for instance ketone-based solvents, benzines, or the like, and will generally contain a suspension of solid residues, such as for instance resins and/or glues of various nature. By using a solvent suitably selected among the recovered ones, or by providing or arranging a suitable composition of the mass of plastic material, it will therefore be possible for the latter to be caused to at least partially dissolve, so that the plastic material impregnated with contaminated solvent is induced to properly soften as a whole. The extent to which this materials will actually soften depends on a number of factors, such as for instance the dilution degree of the solvent used, as well as the degree of impregnation of the plastic material that can be reached with such solvent. Anyway, upon having been so softened, the plastic material will have the consistency of a malleable paste.

Owing to the possibility for the recovered contaminated solvent to be available in a quantity that might not be sufficient to ensure due treatment of the whole mass of plastic material or, conversely, to be available in a fully sufficient amount that might however be not completely or solely of a type suitable for softening the polymers to be handled, part of the mass of plastic material that cannot be treated with the solvent may therefore be micronized so as to enable it to be more readily mixed with the portion of said mass of plastic material that it was the contrary possible to submit to the softening treatment.

Sometimes, there may be found production waste and scraps that are already available in a micronized form, as for instance in the case of epoxy resins. By duly recovering such materials, these can therefore be advantageously mixed with the mass of plastic material that could have been treated with the available solvent, so as to be able to ensure a sufficient amount of material as needed for forming a panel, as this shall be described in greater detail further on. This will practically enable separate operations to micronize unsoftened material to be avoided, thereby not only reducing process costs, but also making it possible for other material to be recovered, which would otherwise have to be treated separately or specially before disposal.

The mass of fibrous material and the mass of softened plastic material, as possibly charged with other micronized plastic material and/or epoxy resins, are then thoroughly mixed, thereby obtaining a compound. If the fibrous material is in the form of a layer of agglomerated fibres, mixing this material with the plastic mass will substantially occur by impregnation.

If, on the contrary, the fibrous material is available in a powder or similar form, mixing it with the mass of softened plastic material originates a compound that is adapted to be evenly spread over a plane so as to form a mat, or mattress, of a homogeneous consistence. This mattress formed with such compound, i.e. the mat of aggregated fibres mixed with plastic material, is then hot-pressed in a press, wherein the pressing temperature is greater than or equal to the temperature needed to cause the plastic material to melt. In particular, this temperature is of at least 180° C.

Hot-pressing this mat of mixed materials, i.e. the layer of aggregated fibres impregnated with plastic material, leads to the production of a semi-finished product that may be advantageously used in the production of panels. This semi-finished product comes out in the form of a thick sheet or mat made up by a fibre aggregate. Hot-pressing will also cause the volatile components of the contaminated solvent that has impregnated the fibrous material to evaporate. Solid residues contained in the solvent remain on the contrary trapped in the fibres of the semi-finished product, thereby favouring the aggregation thereof by boosting the binding effect produced by melting the plastic materials. The fraction of evaporated solvent is duly collected and condensed in a distillation apparatus so as to purify the solvent. It will of course be readily appreciated that a number of operations—all of them of a kind generally known as such in the art—can be performed on such evaporated fraction. These may include the fractional separation of the solvents and the elimination of aqueous components. This practically enables a twofold advantage to be obtained in that solid residues contained in the solvent can on the one side be safely removed therefrom without having to provide for them to be specially treated, while a purified solvent ready for re-use is obtained on the other side. The energy that is normally required and used to submit solid residues contained in used solvents to separation and treatment according to traditional processes and methods can therefore be saved, since it is the binding power that is still available in such residues that is actually used to at least partially bring about an aggregation of the fibrous material making up the semi-finished product.

The semi-finished product obtained with the above-described method is in a form that is most suitable in view of its utilization as cladding or lining panels to sound deadening or heat insulation purposes. In this case, no need arises for the semi-finished product itself to be submitted to any further processing, apart from a simple cutting-to-size operation required to give it dimensions suiting the particular application.

The semi-finished product can however be sent to further processing in view of producing panels of various kinds for application in a plurality of manufacturing and industrial sectors in general, such as the furniture-making industry, the building industry and everywhere there are surfaces to be lined, clad or covered. For such panels to be produced starting from the inventive semi-finished product, the semi-finished mat is transferred onto an impregnation station, where it is permeated by a binding agent in liquid form. A suitable substance in this connection is sodium silicate in the form that is generally known as water-glass in the art. However, other water-soluble glues or binders can be used, as well. In view of facilitating the impregnation of the semi-finished mat and reaching an optimum extent of permeation, the binding agent is forced through the interstices of the mat by submitting the latter to a pressure gradient between the upper surface and the lower surface thereof. The impregnation of the mat with water-glass imparts fire-resistant and self-extinguishing properties to the treated product.

The semi-finished product so impregnated with binding agent is then sent into a drying tunnel, or kiln, or onto a hot-pressing press to dry off the aqueous component of the binder and obtain a finished construction-grade panel. If the drying time is to be desirably cut, while favouring hardening of the binder, such drying process can take place in an environment saturated with carbon dioxide. This gas allows in fact the drying temperature to be increased without running the risk of burning or marring the fibres in the semi-finished mat, since there is no oxygen in the air, at least not to an extent that would enable it to take part in a combustion reaction. Moreover, if the binding agent used is water-glass, the hardening thereof is favoured by the presence of carbon dioxide, thereby contributing to further reduce drying times. The chemical reaction that takes place between sodium silicate and carbon dioxide is as follows:

Na₂O.nSiO₂+H₂O+CO₂→NaHCO₃+nSiO₂

In an advantageous manner, the carbon dioxide used to favour hardening of sodium silicate can be taken from ambient air, thereby contributing to a reduction in the presence of this compound in the atmosphere under a clear improvement in the quality thereof.

Such chemical reaction can also take place at ambient temperature (conventionally set at 20° C.), so that, should any amount of sodium silicate that failed to take part in the chemical reaction be still present in the semi-finished mat after the latter has been dried, this amount will take part in such reaction even after the finished panel has eventually been formed. In addition, also processing scraps that may result when the panel is cut-to-size and/or further processed can be used as a material adapted to reduce the presence of carbon dioxide in ambient air.

The products of the above-described chemical reaction, i.e. sodium bicarbonate and silicon monoxide, can be considered as environmentally friendly, i.e. sustainable products, since they are in fact largely used as such even in the food industry. As a result, it can be plainly stated that producing panels of this kind for use in the furniture-making industry, or the building industry in general, does not give rise to any emission of substances that might pollute the environment.

An example will be set forth below for illustrating an embodiment of the above-described method.

An amount situated anywhere between 550 and 650 kg of fibrous material, such as for instance paper-mill sludge in a dry state or with a moisture content lower than or equal to 5 wt % of the mass, is mixed with at least 120 kg of plastic material that has been preliminarily impregnated and softened with the use of an amount of contaminated solvent ranging from 200 to 500 kg. The resulting compound in powder form is evenly poured and spread over a plane so as to form a kind of mattress. This mattress is then pressed at a temperature of at least 180° C., thereby forming a semi-finished mat having a density of approx. 700 kg/m³. Pressing the mattress in this way causes the solvent contained in the plastic material to evaporate. By properly collecting and condensing the so evaporated solvent fraction, an amount of purified solvent can be produced, which corresponds to approximately 60% of the total amount of contaminated solvent used in the process. The purified solvent does not contain any suspended solid residues, which are in fact retained within the semi-finished mat.

If the semi-finished mat is to be further processed in view of producing panels for use in furniture-making applications, the semi-finished mat is impregnated with a binding agent, as this may for instance consist of an aqueous solution of sodium silicate (water-glass) having a solid content of up to 30 to 35%. The amount of binder used in the application depends on the mechanical and workability properties that the finished panel should desirably have. The impregnated semi-finished mat is then submitted to a drying process in view of drying off the aqueous portion of the binding agent. This drying operation can be carried out in a drying tunnel, or kiln, or in a hot press. A panel produced in this way, and having a thickness of 20 millimeters, has following least characteristics:
Screw extraction resistance (EN 320/93):
   on the face of the panel: 1000 N
   on the edge of the panel: 400 N;
Tensile strength perpendicularly to the faces of the panel (EN 319/92): 0.35 MPa;
Deflection test (EN 310): 13 MPa;
Swelling after 24-hour immersion in water (EN 317): 12%.

Higher values of these and other properties can in all cases be obtained by varying the amount of binder used accordingly.

Fully apparent from the above description is therefore the ability of the present invention to effectively reach the aims and advantages cited afore, through the provision of a method for purifying a contaminated solvent and concurrently producing a semi-finished product for use in the production of panels, in which solvents deriving from a wide variety of production processes can be effectively purified, while at the same time saving energy and resources to a considerable extent. Fully apparent is also the ability of the semi-finished product obtained in accordance with the inventive method to enable panels to be produced, which can be used in a variety of industrial and manufacturing industries, such as for instance the furniture-making industry and the building industry, said panels featuring an improved workability as compared with prior-art panels of fibrous material.

1. A method for purifying a contaminated solvent and concurrently producing a semi-finished product for use in the production of panels, comprising
a) providing a first mass of fibrous material;
b) softening at least part of a second mass of plastic material by impregnating it with a contaminated solvent adapted to at least partially dissolve said plastic material;
c) mixing said fibrous material with the mass of softened plastic material to produce a compound;
d) pressing said compound at a temperature that is at least equal to the melting temperature of said plastic material to obtain a semi-finished panel and a fraction of evaporated solvent.

2. The method according to claim 1, further comprising the step of collecting and distilling said fraction of evaporated solvent.

3. The method according to claim 1, wherein step (c) includes the addition of micronized plastic material.

4. The method according to claim 3, wherein said micronized plastic material is formed of a portion of said second mass of plastic material.

5. The method according to claim 1, wherein step (c) includes the addition of epoxy resins.

6. The method according to claim 1, wherein step (c) is followed by a step (c′) that includes using said compound for forming a mattress being then submitted to a step (d).

7. The method claim 1, wherein said first mass of fibrous material comprises paper-mill sludge.

8. The method according to claim 7, wherein step (a) comprises submitting said sludge to drying through a pressing operation followed by drying, said step (a) further comprising fiberizing said dry sludge.

9. The method according to claim 1, wherein said first mass of fibrous material is in the form of a layer of agglomerated fibres.

10. The method according to claim 1, wherein the temperature at which pressing is carried out in said step (d) is of at least 180° C.

11. The method according to claim 1, wherein said semifinished panel is further impregnated with a binding agent and then submitted to drying.

12. The method according to claim 11, wherein said binding agent is a water-soluble glue.

13. The method according to claim 11, wherein said drying is carried out in an environment saturated with carbon dioxide.

14-15. (canceled)

16. The method according to claim 12, wherein said water-soluble glue is sodium silicate.

17. A semi-finished panel for furniture pieces comprising a solidified compound of a fibrous mass and of a plastic material containing pollutants having binding properties.

18. A panel as claimed in claim 17 further comprising a permealizing binding agent.
